(19) United States
(12) Patent Application Publication
(10) Pub. No.: US 2026/0031646 A1
(43) Pub. Date: Jan. 29, 2026

(54) BATTERY STORAGE SYSTEM AND METHOD FOR CHARGING BATTERY

(71) Applicants: SAMSUNG SDI CO., LTD., Yongin-si (KR); Korea Advanced Institute of Science and Technology, Daejeon (KR)

(72) Inventors: Yong June CHANG, Suwon-si (KR); Gi Jang AHN, Suwon-si (KR); Sang Gug LEE, Daejeon (KR); Min Jae JUNG, Daejeon (KR); Kevin Naoko, Daejeon (KR)

(21) Appl. No.: 19/273,632

(22) Filed: Jul. 18, 2025

(30) Foreign Application Priority Data
Jul. 26, 2024 (KR) 10-2024-0099121

(51) Int. Cl. H02J 7/00

(52) U.S. Cl. CPC H02J 7/007182; H02J 7/0048; H02J 7/005

(57) ABSTRACT

A battery storage system includes a status information measuring part configured to measure status information of a battery, a processor configured to determine a plurality of phase sections of the battery based on the status information and to determine an optimal charging pattern of the battery for each phase section, and a charging device configured to charge the battery based on of the optimal charging pattern.

### CROSS-REFERENCE TO RELATED APPLICATION

The present application claims priority to and the benefit of Korean Patent Application No. 10-2024-0099121, filed on Jul. 26, 2024, in the Korean Intellectual Property Office, the entire disclosure of which is incorporated herein by reference.

### BACKGROUND

### 1. Field

Aspects of the present disclosure relate to a battery storage system and a method of charging a battery.

### 2. Description of the Related Art

Generally, with the recent rapid spread of electronic devices that use batteries, such as mobile phones, laptop computers, and electric vehicles, the demand for secondary batteries with high energy densities and high capacities has been rapidly increasing. Thus, research and development for improvement of the performance of lithium secondary batteries is actively underway.

A lithium secondary battery is a battery including an anode and a cathode, each containing an active material capable of intercalation and deintercalation of lithium ions, and an electrolyte solution, and the lithium secondary battery produces electrical energy due to oxidation and reduction reactions when the lithium ions are intercalated/deintercalated from the anode and the cathode.

The above-described information disclosed in the technology that forms the background of the present invention is only intended to improve understanding of the background of the present invention, and thus may include information that does not constitute the related art.

### SUMMARY

Aspects of the present disclosure are directed to providing a battery storage system and/or a method of charging and managing a battery.

Aspects of the present disclosure are also directed to a battery storage system and/or a method of charging a battery, which includes a design of experiments (DOE) optimization method for long lifetime evaluation of a battery.

Aspects of the present disclosure is also directed to providing a battery storage system and/or a method of charging a battery, which provides a way for developing a battery management technique.

However, the technical problems to be solved by the present disclosure are not limited to the above-described problem, and other problems that have not been mentioned can be clearly understood by those skilled in the art from the following description of the present disclosure.

According to some embodiments of the present disclosure, there is provided a battery storage system including: a status information measuring part configured to measure status information of a battery; a processor configured to determine a plurality of phase sections of the battery based on the status information and to determine an optimal charging pattern of the battery for each phase section; and a charging device configured to charge the battery based on of the optimal charging pattern.

In some embodiments, the status information includes at least one of a dV/dQ profile of the battery, an entropy profile of a cathode of the battery, an entropy profile of an anode of the battery, and a full entropy profile of the battery.

In some embodiments, the processor is configured to determine a plurality of phases based on the dV/dQ profile of the battery.

In some embodiments, the processor is configured to determine a phase transition boundary of the battery from the dV/dQ profile and to determine the plurality of phases based on the phase transition boundary.

In some embodiments, the processor is configured to determine the plurality of phase sections by comparing the plurality of phases with an entropy profile of the battery; and the entropy profile of the battery includes at least one of the entropy profile of the cathode of the battery, the entropy profile of the anode of the battery, and the full entropy profile of the battery.

In some embodiments, the processor is configured to: determine a plurality of operating sections by selecting and combining one or more from the plurality of phase sections; and determine the optimal charging pattern of the battery for each of the plurality of operating sections.

In some embodiments, the plurality of operating sections are state of charge (SoC) boundaries for charging or discharging the battery.

In some embodiments, the processor is configured to: predict an operating lifetime of the battery according to an operating condition of the battery for each of the plurality of operating sections; generate an operating lifetime prediction model of the battery by combining the operating lifetime for the operating condition; and determine the optimal charging pattern through the operating lifetime prediction model.

In some embodiments, the processor is configured to predict the operating lifetime of the battery by comparing a capacity loss ratio after charging and discharging cycles of the battery for each operating section a number of times.

In some embodiments, the operating condition includes at least one of an expected depth of discharge (DOD) and a C-rate.

According to some embodiments of the present disclosure, there is provided a method of charging a battery, including: measuring status information of a battery; determining a plurality of phase sections of the battery based on the status information; determining an optimal charging pattern of the battery for each of the plurality of phase sections; and charging the battery based on the optimal charging pattern.

In some embodiments, the status information includes at least one of a dV/dQ profile of the battery, an entropy profile of a cathode of the battery, and an entropy profile of an anode of the battery.

In some embodiments, the determining of the plurality of phase sections of the battery includes determining a plurality of phases based on the dV/dQ profile of the battery.

In some embodiments, the determining of the plurality of phases includes: determining a phase transition boundary of the battery from the dV/dQ profile; and determining the plurality of phases based on the phase transition boundary.

In some embodiments, the determining of the plurality of phase sections of the battery includes determining the plurality of phase sections by comparing the plurality of phases with an entropy profile of the battery; and the entropy profile of the battery includes at least one of the entropy profile of the cathode of the battery, the entropy profile of the anode of the battery, and a full entropy profile of the battery.

In some embodiments, the determining of the optimal charging pattern of the battery includes: determining a plurality of operating sections by selecting and combining one or more from the plurality of phase sections; and determining the optimal charging pattern of the battery for each of the plurality of operating sections.

In some embodiments, the plurality of operating sections are state of charge (SoC) boundaries for charging or discharging the battery.

In some embodiments, the determining of the optimal charging pattern of the battery further includes: predicting an operating lifetime of the battery according to an operating condition of the battery for each of the plurality of operating sections; generating an operating lifetime prediction model of the battery by combining the operating lifetime for the operating condition; and determining the optimal charging pattern through the operating lifetime prediction model.

In some embodiments, the determining of the optimal charging pattern of the battery further includes: comparing a capacity loss ratio after charging and discharging cycles of the battery for each operating section a number of times; and predicting an operating lifetime of the battery.

In some embodiments, the operating condition includes at least one of an expected depth of discharge (DOD) and a C-rate.

According to some embodiments of the present disclosure, a battery storage system and/or a method of charging a battery may be provided that can be utilized in the development of an efficient charging or management method.

According to some embodiments of the present disclosure, a battery storage system and/or a method of charging a battery, which are capable of designing a long lifetime evaluation DOE of a battery, can be provided.

According to some embodiments of the present disclosure, a battery storage system and/or a method of charging a battery can enable a long battery lifetime.

However, the effects obtainable through the present disclosure are not limited to the above effects, and other technical effects not mentioned will be clearly understood by those skilled in the art from the following description of the present disclosure.

### BRIEF DESCRIPTION OF THE DRAWINGS

The following drawings attached to the present specification illustrate exemplary embodiments of the present disclosure and serve to further assist understanding of the technical idea of the present disclosure together with the detailed description of the present disclosure, which will be described below, so the present disclosure should not be construed as being limited to the details shown in the accompanying drawings, in which:

FIG. 1 is a block diagram illustrating schematic components of a battery storage system according to some embodiments of the present disclosure;

FIG. 2 is a flowchart for describing a method of charging a battery through the battery storage system according to some embodiments of the present disclosure;

FIG. 3 is a flowchart for describing an example of an operation S102 described in FIG. 2 according to some embodiments of the present disclosure;

FIG. 4 is a diagram for describing an example of comparing a dV/dQ profile and an entropy profile according to some embodiments of the present disclosure;

FIG. 5 is a flowchart for describing an example of an operation S103 described in FIG. 2 according to some embodiments of the present disclosure;

FIG. 6 is a diagram illustrating an example of predicting an operating lifetime of a battery according to some embodiments of the present disclosure;

FIG. 7 is a diagram illustrating an example of predicting an operating lifetime of a battery according to some embodiments of the present disclosure;

FIG. 8 is a diagram illustrating optimal C-rates derived according to some embodiments of the present disclosure;

FIG. 9 is a diagram illustrating optimal charging patterns derived according to some embodiments of the present disclosure; and

FIG. 10 is a diagram illustrating an operating lifetime prediction model derived according to some embodiments of the present disclosure.

### DETAILED DESCRIPTION

Hereinafter, exemplary embodiments of the present disclosure will be described in detail with reference to the accompanying drawings. Before describing the present disclosure, terms or words used herein and in the appended claims should not be construed to be limited to ordinary or dictionary meanings, and should be interpreted in accordance with the meaning and concept consistent with the technical spirit of the present disclosure according to the principle that inventors can properly define concepts of terms in order to describe their disclosure in the best way. Therefore, the embodiments described herein and the configurations shown in the drawings are merely some of the most exemplary embodiments of the present disclosure and do not represent all the technical spirit of the present disclosure such that it should be understood that there may be various equivalents and modifications capable of substituting the embodiments and the configurations at the time of filing the present application.

In addition, when used herein, “comprise” and “include” and/or “comprising” and “including” mean specifying the presence of stated shapes, numbers, steps, operations, members, elements, and/or groups thereof and do not exclude the presence or addition of one or more other shapes, numbers, steps, operations, members, elements, and/or groups.

In addition, in order to facilitate understanding of the present disclosure, the accompanying drawings are not drawn to scale and the dimensions of some components may be exaggerated. In addition, the same reference numerals may be assigned to the same components in different embodiments.

The statement that two objects of comparison are “the same” means that they are “substantially the same.” Therefore, substantially identical may include a deviation that is considered low in the art, for example, a deviation within 5%. In addition, uniformity of a parameter in a set or predetermined region may imply uniformity from an average perspective.

Although the terms “first,” “second,” and the like are used to describe various components, these components are substantially not limited by these terms. These terms are only used for distinguishing one component from another component, and unless otherwise stated, it is a matter of course that a first component may also be a second component.

Throughout the specification, unless otherwise specifically stated, each element may be singular or plural.

The arrangement of any component “above (or below)” another component or “on (or under)” another component means that the component may be disposed in contact with an upper surface (or lower surface) of the other component and may mean that other components may be interposed between the component and the other component disposed on (or under) the component.

In addition, when a component is described as “on,” “connected to,” or “coupled to” another component, the components may be directly connected or linked to each other, but it should be understood that another component may be “interposed” between the components, or the components may be “connected,” “coupled,” or “linked” through another component.

As used herein, the term “and/or” includes any and all combinations of one or more of the associated listed items. In addition, the use of “may” when describing embodiments of the present disclosure relates to “one or more embodiments of the present disclosure.” Expressions such as “one or more” and “one or more” preceding a list of elements modify the full list of elements and do not modify individual elements in the list.

Throughout the specification, when “A and/or B” is referred to, this means A, B or A and B unless otherwise stated, and when “C to D” is referred to, this means C or more and D or less unless otherwise stated.

When phrases such as “at least one of A, B, and C,” “at least one of A, B, or C,” “at least one selected from the group of A, B, and C,” and “at least one selected from A, B, and C” are used to specify a list of elements A, B, and C, the phrases may refer to any and all suitable combinations.

The term “use” may be considered synonymous with the term “utilize.” As used herein, the terms “substantially,” “about,” and similar terms are used as terms of approximation rather than terms of degree and are to take into account an inherent variation in value, which is measured or calculated, that a general engineer in the art would recognize.

Although the terms “first,” “second,” “third,” and the like may be used herein to describe various elements, components, area, layers, and/or sections, these elements, components, area, layers, and/or sections should not be limited by these terms. These terms are used to distinguish one element, component, area, drawing layer, or cross section from another element, component, area, drawing layer, or cross section. Thus, a first element, component, region, layer, or section discussed below may be referred to as a second element, component, region, layer, or section without departing from the teachings of the exemplary embodiments.

For ease of description, spatially relative terms such as “beneath,” “below,” “lower,” “above,” and “upper” may be used to describe a relationship between one element or feature and other element(s) or feature(s) as shown in the drawings. Spatially relative positions will be understood to encompass different orientations of the device in use or operation in addition to the orientation depicted in the figures. For example, when a device in the drawing is turned over, elements described as “below” or “beneath” are understood to be “over” or “above” other elements. Therefore, the term “below” can encompass both the upward and downward directions.

The terms used in the present specification are for describing embodiments of the present disclosure and are not intended to limit the present disclosure.

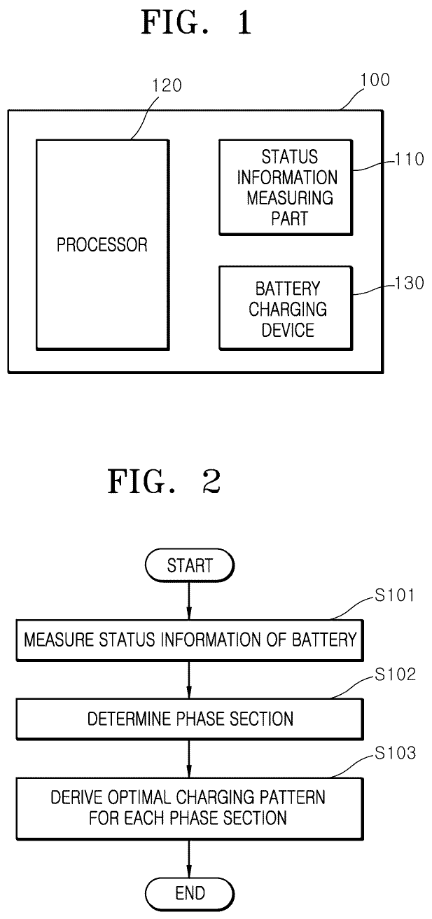

FIG. 1 is a block diagram illustrating schematic components of a battery storage system according to some embodiments of the present disclosure.

In FIG. 1, reference numeral 100 denotes the battery storage system according to some embodiments of the present disclosure.

A battery includes, for example, a secondary battery. The battery includes electrodes including a cathode and an anode, and an electrolyte. In some examples, the electrode includes a substrate, and an active material provided on at least a portion of the substrate. In some examples, an active material included in the cathode may be referred to as a cathode material. In some examples, an active material included in the anode may be referred to as an anode material.

The battery includes a cell that can be charged and discharged a plurality of times. When the charging/discharging of the battery is repeated, charging and discharging efficiency of the battery may be degraded as the number of charging/discharging cycles increases. In some examples, when charging and discharging efficiency of the battery is continuously degraded, a lifetime of the battery ends. Therefore, measures are needed to charge and/or manage a battery while preventing or substantially reducing degradation of a lifetime of the battery.

The battery storage system 100 provides a number of measures for charging and/or managing a battery in order to slow down degradation of a lifetime of the battery. In addition, the battery storage system 100 ensures safety of the battery and allows the battery to be quickly charged within a range that ensures a maximum lifetime of the battery.

To this end, the battery storage system 100 includes a status information measuring part 110, a processor 120, and/or a charging device 130. However, components included in the battery storage system 100 are not limited to the components shown in FIG. 1. The battery storage system 100 may include only some of the components shown in FIG. 1 and/or may include additional components in addition to the components shown in FIG. 1. For example, the battery storage system 100 may further include a memory, a communication part, an output part, and the like.

The status information measuring part 110 measures status information of a battery. The status information includes thermodynamic information on a material structure of the battery.

For example, during a charging/discharging process, a structural change may occur in the battery. For example, during a charging/discharging process, an anode material and a cathode material may undergo structural changes such as particle cracking and/or instability of a solid-electrolyte interfacial layer. Thus, the battery storage system 100 according to some embodiments of the present disclosure monitors the anode material and/or the cathode material to improve the lifetime of the battery.

For example, the status information includes at least one of a dV/dQ profile of the battery, an entropy profile of the cathode of the battery, and an entropy profile of the anode of the battery.

However, the status information is not limited thereto, and the status information may further include one or a combination of state functions relating to at least one of enthalpy and Gibbs energy of the battery.

The status information measuring part 110 may measure the entropy profile of the cathode of the battery and/or the entropy profile of the anode of the battery through, for example, a potential difference method or a calorimeter method.

The processor 120 may control all or some of the components included in the battery storage system 100. The processor 120 may be embedded in the battery storage system 100 in the form of, for example, a central processing unit (CPU) or a main control unit (MCU). In some examples, the processor 120 may be externally mounted on the battery storage system 100 and may transmit and receive data to and from the battery storage system 100 through a communication part.

The processor 120 determines a plurality of phase sections of the battery on the basis of the status information and an optimal charging pattern of the battery for each phase section.

In some examples, each of the plurality of phase sections represents a section in which a property of a material does not change. Thus, it may be sufficient for battery charging to be performed by one charging pattern and/or condition in each of the plurality of phase sections.

In some examples, the optimal charge pattern may be a charge pattern (e.g., the best charge pattern) capable of charging the battery quickly (e.g., most quickly) and/or safely for each phase section. That is, the optimal charging pattern is a charging pattern capable of charging the battery while substantially reducing (e.g., minimizing) damage to the battery.

The charging device 130 charges the battery on the basis of the optimal charging pattern.

For example, the charging device 130 may perform charging and/or discharging in a fixed condition throughout one phase section. The charging device 130 may perform charging and/or discharging of different patterns in different phase sections. For example, when a phase section is changed, the charging device 130 may change a charging pattern from one of constant current (CC) charging, constant voltage (CV) charging, pulse charging, burped charging, or trickle charging to another charging pattern. For example, when the phase section is changed, the charging device 130 may change the charging pattern from a CC/CV charging mode to a pulse charging mode.

In this way, the battery storage system 100 according to some embodiments of the present disclosure may derive the optimal charging pattern of the battery on the basis of the status information of the battery. In addition, the battery storage system 100 may prevent the lifetime of the battery from being degraded or substantially reduce such degradation by charging the battery according to the optimal charging pattern.

Hereinafter, the operation method of the battery storage system 100 will be described in more detail.

FIG. 2 is a flowchart for describing a method of charging a battery through the battery storage system according to some embodiments of the present disclosure.

The battery storage system 100 according to some embodiments of the present disclosure may be operated according to, for example, the flowchart described in FIG. 2. The battery storage system 100 may charge and/or manage a battery through such an operation. Hereinafter, a method of charging a battery by the battery storage system 100 will be described.

As shown in FIG. 2, the method of charging a battery includes measuring status information of the battery (operation S101). The status information measuring part 110 may measure status information of the battery. In some examples, the status information of the battery includes at least one of state functions relating to at least one of, for example, a dV/dQ profile of the battery, an entropy profile of a cathode of the battery, an entropy profile of an anode of the battery, and an enthalpy and Gibbs energy of the battery, or a combination thereof. A detailed description of operation S101 may be the same as or similar to the description of the status information measuring part 110 in FIG. 1, thus a description thereof may not be repeated.

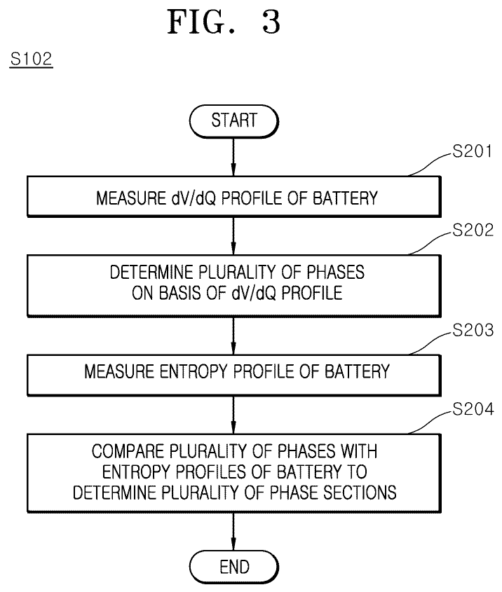

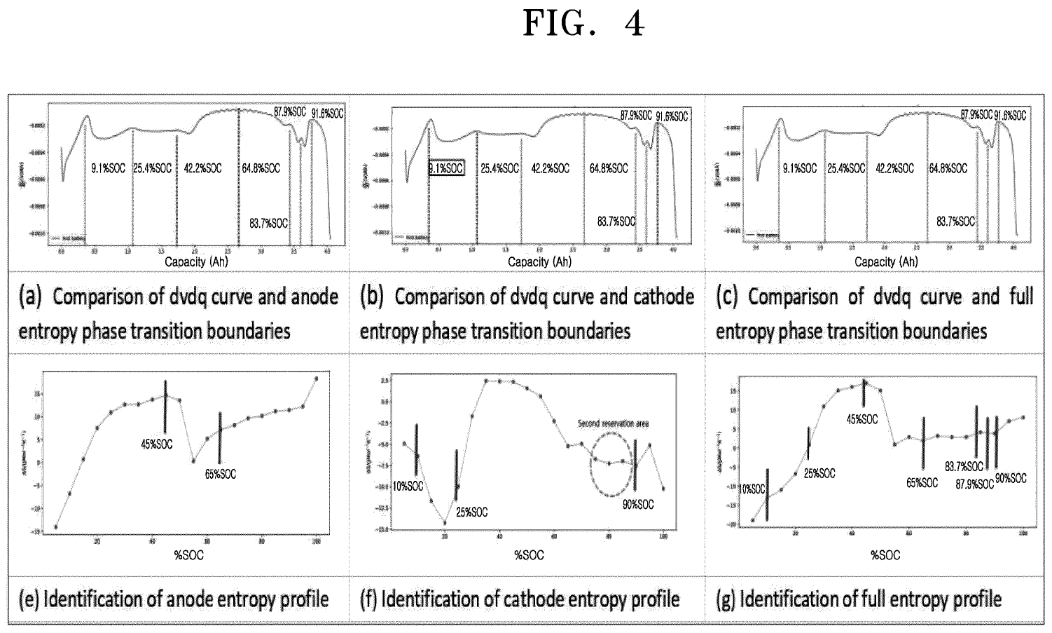

As shown in FIG. 2, the method of charging a battery includes determining a phase section of the battery (operation S102). The processor 120 determines the phase section of the battery. The phase section of the battery represents a section in which properties of a material do not change. Operation S102 will be described in more detail with reference to FIGS. 3 and 4.

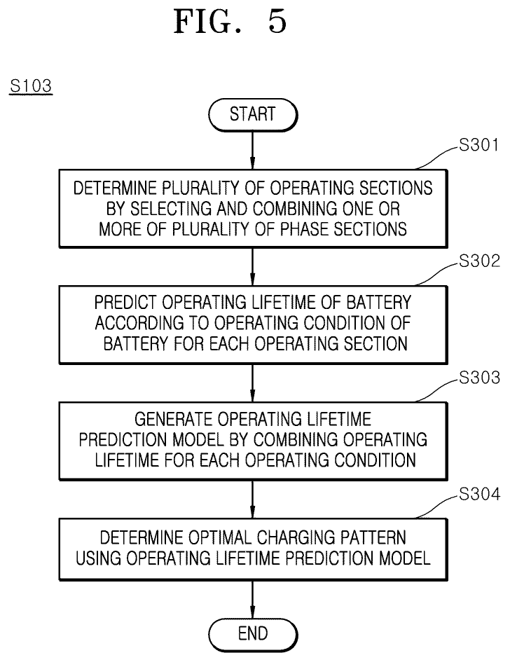

As shown in FIG. 2, the method of charging a battery includes deriving an optimal charging pattern for each determined phase section of the battery (operation S103). The processor 120 derives the optimal charging pattern for each phase section of the battery. Operation S102 will be described in more detail with reference to FIGS. 5 to 10.

As shown in FIG. 2, the method of charging a battery includes charging the battery according to the derived optimal charging pattern (operation S104). The battery charging device 130 charges the battery according to the optimal charging pattern derived for each phase section. A description of operation S104 is the same as or similar to the description of the battery charging device 130 in FIG. 1, thus a description thereof may not be repeated.

In this way, the method of charging a battery according to some embodiments of the present disclosure may prevent lifetime degradation of the battery or substantially reduce such degradation, and efficiently charge the battery by charging and/or managing the battery on the basis of the status information of the battery. Hereinafter, the method of charging a battery will be described in more detail.

FIG. 3 is a flowchart for describing an example of the operation S102 described in FIG. 2 according to some embodiments of the present disclosure.

FIG. 4 is a diagram for describing an example of comparing a dV/dQ profile and an entropy profile according to some embodiments of the present disclosure. In some examples, FIG. 4 shows, for example, status information of a lithium nickel cobalt manganese (NCM) battery as an example of status information of a battery.

In operation S102 described in FIG. 2, the battery storage system 100 according to some embodiments of the present disclosure may be operated according to, for example, the flowchart described in FIG. 3. Hereinafter, the method of charging a battery by the battery storage system 100 will be described.

As shown in FIG. 3, the method of charging a battery includes measuring a dV/dQ profile of the battery (operation S201).

The processor 120 measures the dV/dQ profile of the battery through the status information measuring part 110.

For example, FIGS. 4A to 4C show measured dV/dQ profiles of the battery. In some examples, FIG. 4A shows a dV/dQ profile of the anode of the battery. In some examples, FIG. 4B shows a dV/dQ profile of the cathode of the battery. In some examples, FIG. 4C shows an overall dV/dQ profile of the battery.

As shown in FIG. 3, the method of charging a battery includes determining a plurality of phases on the basis of the dV/dQ profiles (operation S202).

The processor 120 determines the plurality of phases on the basis of the dV/dQ profiles.

In some examples, the phase represents a section in which physical properties are uniform. For example, in the plurality of phases, a change in organization (e.g., state) of a material may occur between the phases. The change in organization (e.g., state) of the material includes, for example, a change from liquid to solid, or from one crystal structure to another crystal structure.

For example, the processor 120 determines a peak from the dV/dQ profile. The peak may denote an occurrence of a phase transition. For example, the processor 120 determines a phase transition boundary of the battery from the dV/dQ profile. In addition, for example, the processor 120 determines a plurality of phases on the basis of the phase transition boundary. Thus, the processor 120 may determine the plurality of phases on the basis of the peak of the dV/dQ profile.

As shown in FIG. 3, the method of charging a battery includes measuring an entropy profile of the battery (operation S203).

The processor 120 measures at least one of the entropy profile of the cathode of the battery and the entropy profile of the anode of the battery through the status information measuring part 110.

For example, FIGS. 4D to 4E show entropy profiles of the battery. In some examples, FIG. 4D shows the entropy profile of the anode of the battery. In some examples, FIG. 4E shows the entropy profile of the cathode of the battery.

For example, when only one of the entropy profile of the cathode of the battery and the entropy profile of the anode of the battery is measured, the processor 120 determines the one measured profile as the full entropy profile of the battery.

For example, when the entropy profile of the cathode of the battery and the entropy profile of the anode of the battery are measured, the processor 120 determines the full entropy profile of the battery on the basis of the entropy profile of the cathode of the battery and the entropy profile of the anode of the battery. In some examples, the processor 120 may determine the full entropy profile of the battery through the sum of the entropy profile of the anode and the entropy profile of the cathode.

For example, FIG. 4F may be represented by the sum of FIG. 4D and FIG. 4E. For example, FIG. 4F shows the full entropy profile of the battery. On the other hand, conversely, FIG. 4D and FIG. 4E may also be represented by the separation of FIG. 4F.

As shown in FIG. 3, the method of charging a battery includes determining the plurality of phase sections by comparing the plurality of phases with the entropy profiles of the battery (operation S204).

The processor 120 determines the plurality of phase sections by comparing the plurality phases with the full entropy profile of the battery. In some examples, the plurality of phase sections may represent state of charge (SoC) boundaries for charging or discharging the battery.

For example, the processor 120 compares the plurality of phases determined from the dV/dQ profile with the entropy profile of the battery.

For example, as shown in FIG. 4A, the processor 120 may compare the plurality of phases determined from the dV/dQ profile of the anode with the entropy profile of the anode of the battery. For example, the processor 120 may compare the peak of the dV/dQ profile of the anode with the phase transition boundary of the entropy profile of the anode.

For example, as shown in FIG. 4B, the processor 120 may compare the plurality of phases determined from the dV/dQ profile of the cathode with the entropy profile of the cathode of the battery. For example, the processor 120u may compare the peak of the dV/dQ profile of the cathode with the phase transition boundary of the entropy profile of the cathode.

For example, as shown in FIG. 4C, the processor 120 may compare the plurality of phases determined from the full dV/dQ profile of the battery with the full entropy profile of the battery. For example, the processor 120 may compare the peak of the full dV/dQ profile of the battery with the phase transition boundary of the full entropy profile of the battery.

In this way, the processor 120 derives the plurality of phase sections. In some examples, the phase section is a section determined as constituting a phase transition boundary through cross-validation of the dV/dQ profile and the entropy profile.

In this way, the processor 120 may improve reliability of the phase sections by cross-verifying a boundary of each of the dV/dQ profile and the entropy profile. In addition, the processor 120 may determine which electrode forms each phase boundary by utilizing all the dV/dQ profiles and the entropy profiles of the anode, the cathode, and the battery.

FIG. 5 is a flowchart for describing an example of the operation S103 described in FIG. 2 according to some embodiments of the present disclosure.

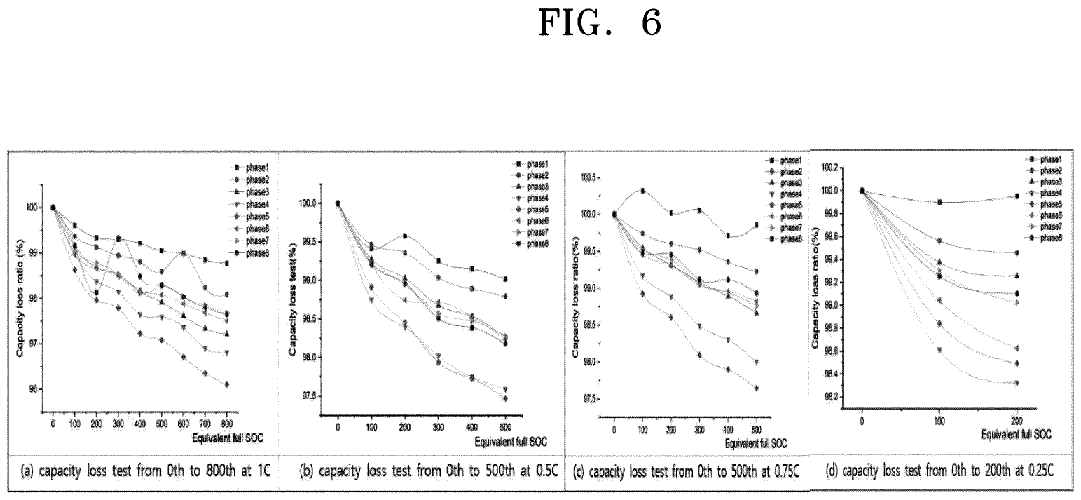

FIG. 6 is a diagram illustrating an example of predicting an operating lifetime of a battery according to some embodiments of the present disclosure.

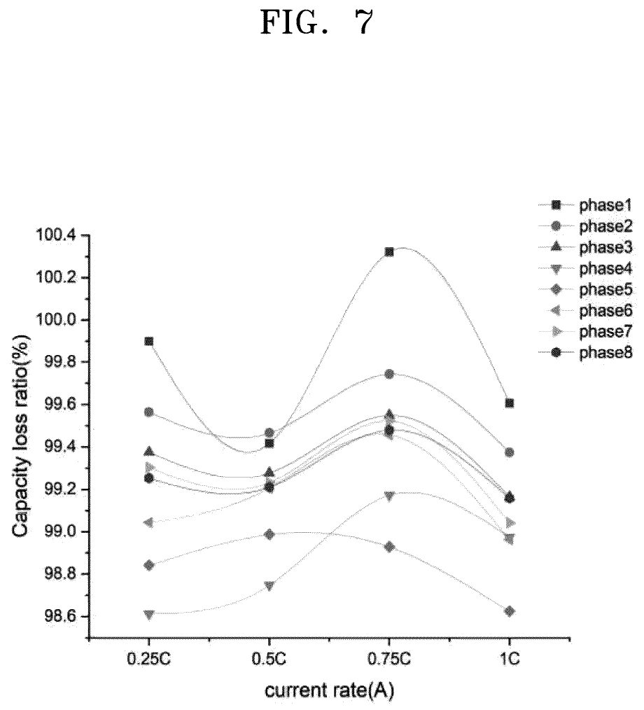

FIG. 7 is a diagram illustrating an example of predicting an operating lifetime of a battery according to some embodiments of the present disclosure.

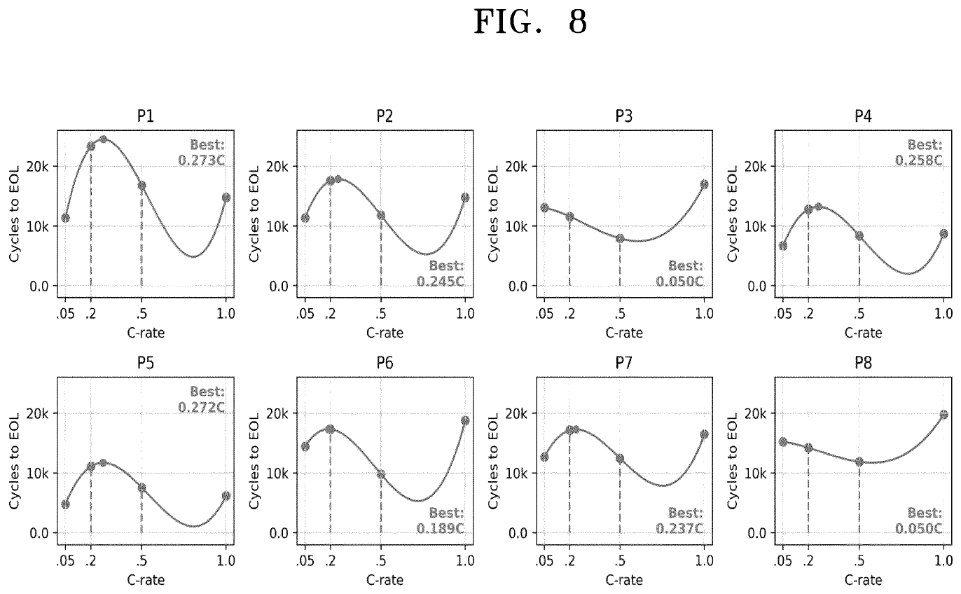

FIG. 8 is a diagram illustrating an optimal C-rate derived according to some embodiments of the present disclosure.

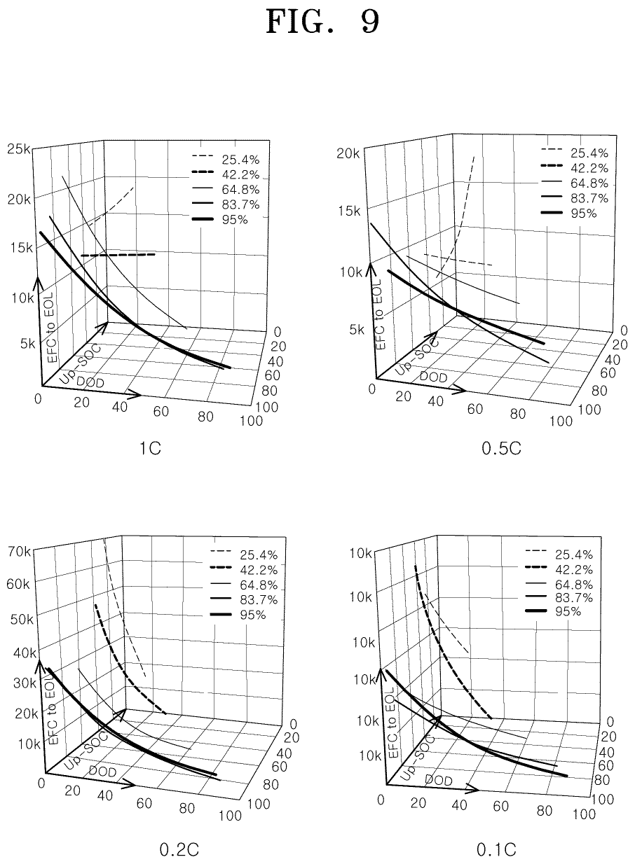

FIG. 9 is a diagram illustrating an operating lifetime prediction model derived according to some embodiments of the present disclosure.

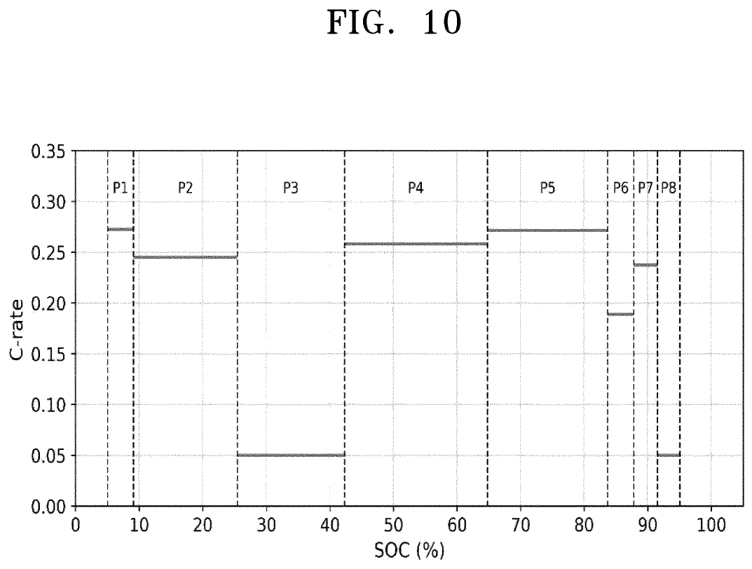

FIG. 10 is a diagram illustrating an optimal charging pattern derived according to some embodiments of the present disclosure.

In operation S103 described in FIG. 2, the battery storage system 100 according to some embodiments of the present disclosure may be operated according to, for example, the flowchart described in FIG. 5. Hereinafter, the method of charging a battery by the battery storage system 100 will be described.

As shown in FIG. 5, the method of charging a battery includes determining a plurality of operating sections by selecting and combining one or more of the plurality of phase sections (operation S301).

The processor 120 selects one or more phase sections from the plurality of phase sections. The processor 120 determines the plurality of operating sections from the selected one phase section or a combination of the plurality of phase sections. For example, the processor 120 may combine the plurality of adjacent phase sections and determine the combination as one operating section.

In some examples, the operating sections may represent an SoC boundary for charging or discharging the battery. In some examples, the SoC represents a charging status of the battery as a percentage. For example, when the battery is in a discharged state, the SoC may be represented as 0%. Further, when the battery is in a fully charged state, the SoC may be represented as 100%.

As shown in FIG. 5, the method of charging a battery includes predicting an operating lifetime of the battery according to an operating condition of the battery for each operating section (operation S302).

For example, the processor 120 predicts the operating lifetime of the battery by comparing a capacity loss ratio for each operating section after a set or predetermined number of charging and discharging cycles. The operating condition includes at least one of, for example, an expected depth of discharge (DOD), a C-rate, and an upper/lower SoC bound. For example, the processor 120 predicts the operating lifetime of the battery in the operating sections for each condition. As used herein, the C-rate refers to the speed at which a battery can be charged or discharged, expressed as a multiple of the battery's nominal capacity. For example, a 1 C rate means the battery can be fully charged or discharged in one hour, while a 0.50 rate means it can do so in two hours.

FIGS. 6 and 7 are diagrams for describing an example in which the processor 120 predicts the operating lifetime of the battery for each operating section.

FIG. 6 shows aging tests performed on the battery at a constant temperature and different charging and discharging currents. In some examples, FIG. 6 shows a capacity loss ratio according to each condition for each operating section (phase 1 to phase 8). In some examples, FIG. 6A is a graph showing a capacity loss ratio of the battery during 800 cycles when the charge/discharge current is 1 C. FIG. 6B is a graph showing a capacity loss ratio of the battery during 500 cycles when the charge/discharge current is 0.5 C. FIG. 6C is a graph showing a capacity loss ratio of the battery during 500 cycles when the charge/discharge current is 0.75 C. FIG. 6D is a graph showing a capacity loss ratio of the battery during 200 cycles when the charge/discharge current is 0.25 C.

In this way, it can be seen that the phase for each operating section varies depending on the charge/discharge current.

FIG. 7 is a graph showing a capacity loss ratio in each operating section after 100 initial charge/discharge cycles in order to compare aging results of the battery at different current values. In the example of FIG. 7, it can be seen that optimal currents for reducing (e.g., minimizing) capacity loss are concentrated at current rates of 0.75 C and 0.5 C in most of the operating sections.

In this way, the processor 120 may determine aging characteristics and/or optimal currents utilized for charging the battery through the capacity loss ratio according to an increase in cycle of the battery a given number of times.

On the basis of this information, the processor 120 may predict the operating lifetime of the battery for each operating section.

For example, FIG. 8 shows graphs illustrating result data when a charging/discharging test is repeated while a value of a constant current (C-rate) is changed in each operating section. In some examples, in FIGS. 8, P1 to P8 denote a plurality of operating sections. In this way, the processor 120 may predict the operating lifetime of the battery for each operating section of the battery. In addition, the processor 120 may determine an optimal charging pattern that is utilized for achieving such an operating lifetime. For example, the processor 120 may determine that an optimal current is 0.273C in P1 and an optimal current is 0.245 C in P2.

As shown in FIG. 5, the method of charging a battery includes generating an operating lifetime prediction model by combining an operating lifetime for each operating condition (operation S303).

The processor 120 may generate an operating lifetime prediction model for a wider range of SoC boundary conditions by combining a battery operating lifetime for each condition.

For example, the processor 120 may generate operating lifetime prediction models as shown in FIG. 9. In some examples, FIG. 9A shows an operating lifetime prediction model of the battery in which charging and discharging are performed at various C-rates at 1 C. In some examples, FIG. 9B shows an operating lifetime prediction model of the battery in which charging and discharging are performed at various C-rates at 0.5 C. In some examples, FIG. 9C shows an operating lifetime prediction model of the battery in which charging and discharging are performed at various C-rates at 0.2 C. In some examples, FIG. 9D shows an operating lifetime prediction model of the battery in which charging and discharging are performed at various C-rates at 0.1 C.

As shown in FIG. 5, the method of charging a battery includes determining an optimal charging pattern using the operating lifetime prediction model (operation S304).

The processor 120 may determine an optimal charging pattern for a corresponding battery through the operating lifetime prediction model.

For example, FIG. 10 shows the optimal charging pattern determined by the processor 120. FIG. 10 shows an example in which the number of operating sections of a battery is eight. In some examples, each of the plurality of operating sections P1 to P8 may have an optimal charging pattern in which charging is performed by a different charging current value (C-rate). In some examples, on the basis of the results of FIGS. 6 to 8, the processor 120 may determine the C-rate in the optimal charging pattern to be in the range of 0.5 C or less.

The battery charging device 130 may charge the battery on the basis of the optimal charging pattern. For example, even when the battery charging device 130 charges one battery, the battery charging device 130 may charge the battery according to different charging patterns for the plurality of operating sections included in one battery. For example, the battery charging device 130 may charge the battery with a current of 0.273 C in section P1, a current of 0.245 C in section P2, a current of 0.050 C in section P3, a current of 0.258 C in section P4, a current of 0.272 C in section P5, a current of 0.189 C in section P6, a current of 0.237 C in section P7, and a current of 0.050 C in section P8. The optimal charging pattern may include a pattern in which the charging current decreases from P1 to P3, increases from P3 to P5, decreases in P6, increases in P7, and then decreases again in P8.

As described above, the battery storage system 100 according to some embodiments of the present disclosure can extend the lifetime of the battery by charging the battery under the optimal charging pattern.

While the present disclosure has been described with reference to the embodiments shown in the drawings, these embodiments are merely illustrative and it should be understood that various modifications and equivalent other embodiments can be derived by those skilled in the art on the basis of the embodiments described herein.

Therefore, the technical scope of the present disclosure should be defined by the appended claims and their equivalents.

What is claimed is:

1. A battery storage system comprising:
a status information measuring part configured to measure status information of a battery;
a processor configured to determine a plurality of phase sections of the battery based on the status information and to determine an optimal charging pattern of the battery for each phase section; and
a charging device configured to charge the battery based on of the optimal charging pattern.

2. The battery storage system of claim 1, wherein the status information comprises at least one of a dV/dQ profile of the battery, an entropy profile of a cathode of the battery, an entropy profile of an anode of the battery, and a full entropy profile of the battery.

3. The battery storage system of claim 2, wherein the processor is configured to determine a plurality of phases based on the dV/dQ profile of the battery.

4. The battery storage system of claim 3, wherein the processor is configured to determine a phase transition boundary of the battery from the dV/dQ profile and to determine the plurality of phases based on the phase transition boundary.

5. The battery storage system of claim 3, wherein:
the processor is configured to determine the plurality of phase sections by comparing the plurality of phases with an entropy profile of the battery; and
the entropy profile of the battery comprises at least one of the entropy profile of the cathode of the battery, the entropy profile of the anode of the battery, and the full entropy profile of the battery.

6. The battery storage system of claim 1, wherein the processor is configured to:
determine a plurality of operating sections by selecting and combining one or more from the plurality of phase sections; and
determine the optimal charging pattern of the battery for each of the plurality of operating sections.

7. The battery storage system of claim 6, wherein the plurality of operating sections are state of charge (SoC) boundaries for charging or discharging the battery.

8. The battery storage system of claim 7, wherein the processor is configured to:
predict an operating lifetime of the battery according to an operating condition of the battery for each of the plurality of operating sections;
generate an operating lifetime prediction model of the battery by combining the operating lifetime for the operating condition; and
determine the optimal charging pattern through the operating lifetime prediction model.

9. The battery storage system of claim 8, wherein the processor is configured to predict the operating lifetime of the battery by comparing a capacity loss ratio after charging and discharging cycles of the battery for each operating section a number of times.

10. The battery storage system of claim 8, wherein the operating condition comprises at least one of an expected depth of discharge (DOD) and a C-rate.

11. A method of charging a battery, comprising:
measuring status information of a battery;
determining a plurality of phase sections of the battery based on the status information;
determining an optimal charging pattern of the battery for each of the plurality of phase sections; and
charging the battery based on the optimal charging pattern.

12. The method of claim 11, wherein the status information comprises at least one of a dV/dQ profile of the battery, an entropy profile of a cathode of the battery, and an entropy profile of an anode of the battery.

13. The method of claim 12, wherein the determining of the plurality of phase sections of the battery comprises determining a plurality of phases based on the dV/dQ profile of the battery.

14. The method of claim 13, wherein the determining of the plurality of phases comprises:
determining a phase transition boundary of the battery from the dV/dQ profile; and
determining the plurality of phases based on the phase transition boundary.

15. The method of claim 13, wherein:
the determining of the plurality of phase sections of the battery comprises determining the plurality of phase sections by comparing the plurality of phases with an entropy profile of the battery; and
the entropy profile of the battery comprises at least one of the entropy profile of the cathode of the battery, the entropy profile of the anode of the battery, and a full entropy profile of the battery.

16. The method of claim 11, wherein the determining of the optimal charging pattern of the battery comprises:
determining a plurality of operating sections by selecting and combining one or more from the plurality of phase sections; and
determining the optimal charging pattern of the battery for each of the plurality of operating sections.

17. The method of claim 16, wherein the plurality of operating sections are state of charge (SoC) boundaries for charging or discharging the battery.

18. The method of claim 17, wherein the determining of the optimal charging pattern of the battery further comprises:
predicting an operating lifetime of the battery according to an operating condition of the battery for each of the plurality of operating sections;
generating an operating lifetime prediction model of the battery by combining the operating lifetime for the operating condition; and
determining the optimal charging pattern through the operating lifetime prediction model.

19. The method of claim 18, wherein the determining of the optimal charging pattern of the battery further comprises:
comparing a capacity loss ratio after charging and discharging cycles of the battery for each operating section a number of times; and
predicting an operating lifetime of the battery.

20. The method of claim 18, wherein the operating condition comprises at least one of an expected depth of discharge (DOD) and a C-rate.
